(19) United States
(12) Patent Application Publication
(10) Pub. No.: US 2005/0172071 A1
(43) Pub. Date: Aug. 4, 2005

(54) Method and apparatus for identifying a digital recording source

(76) Inventors: Robert A. Edmonds, Saratoga, CA (US); Kevin J. McDonnell, Pleasanton, CA (US); Johan De Meulder, Kessel (BE)

Correspondence Address: MOSER, PATTERSON & SHERIDAN L.L.P., 595 SHREWSBURY AVE, STE 100, FIRST FLOOR, SHREWSBURY, NJ, 07702, US

(21) Appl. No.: 10/771,984

(22) Filed: Feb. 3, 2004

(51) Int. Cl. G06F 12/00

(52) U.S. Cl. 711/112; 711/170

(57) ABSTRACT

A method and apparatus for uniquely identifying a digital storage medium is described. In one example, at least one physical attribute of a recording surface is determined. For example, at least one position of the recording surface may be associated with at least one data unit stored on the digital storage medium. Identification indicia is formed from the at least one physical attribute. In another example, a digital recording source is associated with a digital storage medium that was replicated from the source. Identification indicia associated with the digital recording source is obtained by analyzing at least one physical attribute of a recording surface on the digital storage medium. The identification indicia is then compared with the at least one physical attribute to determine if the digital recording source was in fact used to replicate the digital storage medium.

### BACKGROUND OF THE INVENTION

1. Field of the Invention

The present invention relates generally to the field of optical storage media and, more particularly, to a method and apparatus for identifying a digital recording source used to replicate optical storage media.

2. Description of the Related Art

Optical storage media, such as digital versatile disc (DVD) and compact disc (CD) media, are used for various purposes. For example, optical storage media may be used to store video, audio, and/or data information. Large-scale reproduction of optical storage media is known as replication. The video, audio, and/or data information is processed to form a source image in a pre-mastering process. After pre-mastering, the source image is written onto a master digital recording source, typically formed of glass, using a laser recording system. The glass master is then used to create metal stampers, which are in turn used in an injection molding process to create replica optical storage media.

The information stored on optical storage media is often copyrighted material and thus the duplication or replication of such optical storage media is strictly controlled. In an effort to prevent unauthorized copying, an International Federation of the Phonographic Industry (IFPI) code is typically recorded in human-readable fashion on the optical storage media. The IFPI code is composed of symbols that indicate a manufacturer, a factory, a source disc number, and the like associated with the optical storage medium. To determine if a given optical storage medium is an authorized copy, the IFPI code may be used to verify that an authorized digital recording source was used to make the optical storage medium bearing the IFPI code. However, savvy copiers may circumvent the IFPI coding system by fraudulently copying a valid IFPI code onto unauthorized copies of the optical storage medium.

Therefore, there exists a need in the art for a method and apparatus that uniquely identifies a digital recording source of optical storage media to prevent unauthorized copying.

### SUMMARY OF THE INVENTION

A method and apparatus for uniquely identifying a digital storage medium is described. In one embodiment, at least one physical attribute of a recording surface is determined. For example, at least one position of the recording surface may be associated with at least one data unit stored on the digital storage medium. Identification indicia is formed from the at least one physical attribute.

In another embodiment, a digital recording source is associated with a digital storage medium that was replicated from the source. Identification indicia associated with the digital recording source is obtained by analyzing at least one physical attribute of a recording surface on the digital storage medium as described above. In an embodiment, the digital storage medium is analyzed to associate at least one position on the recording surface with at least one data unit stored on the digital storage medium. The identification indicia is then compared with the at least one physical attribute to determine if the digital recording source was in fact used to replicate the digital storage medium.

### BRIEF DESCRIPTION OF THE DRAWINGS

So that the manner in which the above recited features of the invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a block diagram showing an exemplary recording system for creating a master digital recording source;

FIG. 2 depicts a diagram showing an exemplary physical layout of data on a recording surface of a master digital recording source;

FIG. 3 depicts a block diagram showing an embodiment of a system for identifying unique physical indicia for a digital storage medium in accordance with the invention;

FIG. 4 depicts a block diagram showing an embodiment of a system for associating a master digital recording source with a replica optical storage medium in accordance with the invention;

FIG. 5 depicts a flow diagram showing one embodiment of a process for identifying unique physical indidia for a digital storage medium in accordance with the invention;

FIG. 6 depicts a flow diagram showing another embodiment of a process for identifying unique physical indicia for a digital storage medium in accordance with the invention; and

FIG. 7 depicts a flow diagram showing one embodiment of a process for associating a digital recording source with a digital storage medium in accordance with the invention.

### DETAILED DESCRIPTION OF THE INVENTION

A method and apparatus for uniquely identifying a digital recording source is described. The invention is described in the context of uniquely identifying a master digital recording source used to replicate digital versatile disc (DVD) media. Those skilled in the art, however, will appreciate that the present invention may be used to uniquely identify other types of digital recording sources of optical storage media, such as a master source used to replicate compact disc (CD) media.

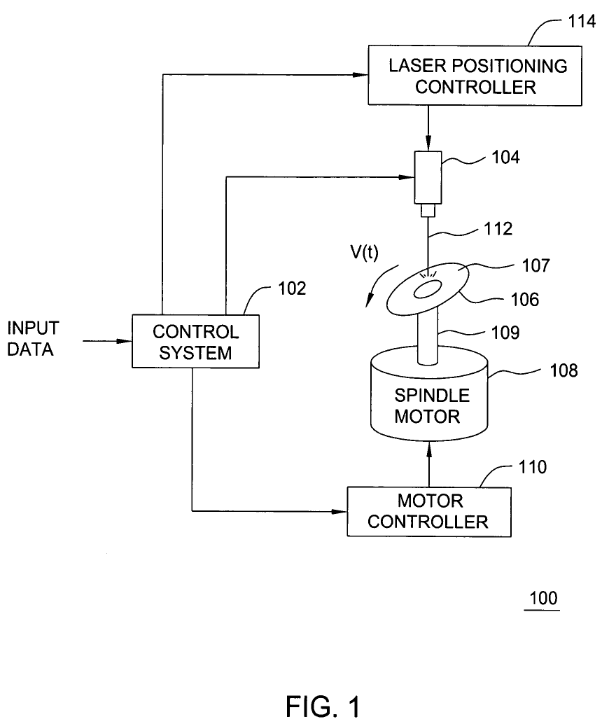

FIG. 1 depicts a block diagram showing an exemplary recording system 100 for creating a master digital recording source. The recording system 100 illustratively comprises a control system 102, a laser source 104, a spindle motor 108, a motor controller 110, and a laser positioning controller 114. The control system 102 is coupled to the laser 104, the laser positioning controller 114, and the motor controller 110. The motor controller 110 is coupled to the spindle motor 108. The spindle motor 108 includes a shaft 109 for supporting a master digital recording source 106 (hereinafter referred to as the master 106). The master 106 comprises a digital recording medium for use in the replication of optical storage media, such as DVD media or CD media. For example, the master 106 may comprise a glass disc having a recording surface 107. The laser 104 provides a recording beam 112 for writing data to the recording surface 107 of the master 106. The recording surface 107 may comprise more than one layer for storing data. For simplicity, however, the following description assumes a recording surface 107 having a single layer. Those skilled in the art will readily appreciate that the principles of the invention also apply to a recording surface 107 having multiple recording layers.

Recording system 100 operates in a well-known manner. Briefly stated, input data is coupled to the control system 102. The input data is derived from an image stored on a source (not shown), such as a hard disc drive, an optical storage medium (e.g., DVD-ROM), a tape storage device, or the like. The input data comprises a series of sectors or blocks that encode the source image in accordance with a well-known specification for the particular type of optical storage media. For example, for CD-ROM media, each sector includes 2353 bytes of data. Before being stored on the master 106, the encoded input data is modulated and interleaved around the master 106. Notably, the encoded input data is modulated to produce a sequence of fixed-length data units (referred to herein as “symbols”). For example, for CD-ROM media, the input data is modulated using the well-known eight-to-fourteen modulation (EFM) scheme, where each eight bit word of the input data is encoded as a seventeen bit symbol (fourteen bits to represent the eight-bit word plus three merging bits). For DVD media, the input data is modulated using a similar eight-to-sixteen modulation scheme, referred to as EFM+. In general, the input data is converted into a sequence of symbols to be written to the master 106.

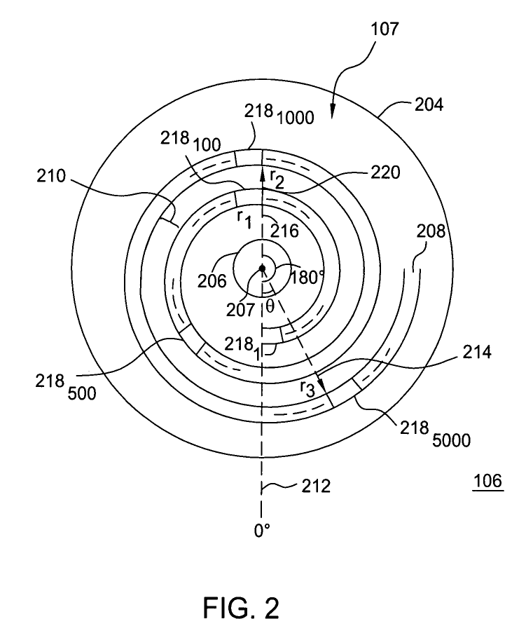

The control system 102 couples control signals to the laser 104 for causing the recording beam 112 to write the symbols to the master 106. The recording beam 112 forms a sequence of convex or concave pits in the recording surface 107 of the master. 106. The pits are separated by lands. The pits and lands of each symbol are arranged within a spiral track. An exemplary configuration of symbols on the recording surface 107 is shown and described in detail below with respect to FIG. 2.

In addition, the control system 102 couples control signals to the motor controller 110 and the laser positioning controller 114. The motor controller 110 in turn couples control signals to the spindle motor 108 for rotating the master 106. The spindle motor 108 rotates the master 106 at a given constant angular cutting velocity (CAV) or constant linear cutting velocity (CLV), denoted v(t). The laser positioning controller 114 moves the laser 104 to create the spiral track. Alternatively, the recording system 100 may include a stationary laser, and the spindle motor assembly may move to create the spiral track. With an identical cutting velocity, the physical placement of the symbols on the recording surface 107 will be identical for each unique master 106 produced by the recording system 100 and, since each symbol is of fixed-length, each symbol will have the same physical length on the recording surface 107. That is, with an identical cutting velocity, a given symbol will start and stop at identical physical positions on the recording surface 107 of any unique master 106 produced by the recording system 100.

However, the cutting velocity, v(t), actually varies over time due to various random system variables, such as an inaccurate spindle motor 108 or hysteresis within the motor controller 110. For example, a given cutting velocity may be set between 1.2 and 1.4 m/s. As such, a master 106 produced by the recording system 100 will exhibit a unique physical placement of symbols on the recording surface 107. That is, a given symbol will start and stop at different physical positions on the recording surface 107 of each master 106 produced by the recording system 100. Any replica made using the master 106 will have identical physical symbol placement as the master 106. Due to the number of random variables in the recording system 100, the probability that any two masters 106 will exhibit identical physical symbol placement is insignificant. As described in more detail below, the invention advantageously employs the unique physical placement of symbols on the recording surface 107 of the master 106 to provide unique physical indicia (a “fingerprint”) for the master 106. After the master 106 is used to replicate optical storage media, the unique physical indicia corresponding to the master 106 may be used to determine if a given replica was derived from the master 106 and is thus a valid copy thereof.

FIG. 2 depicts a diagram of an exemplary physical layout of data on the recording surface 107 of the master 106. The master 106 includes an inner diameter 206 and an outer diameter 204. A spiral track 208 having a track pitch 210 is recorded onto the recording surface 107 between the inner diameter 206 and the outer diameter 204. For example, for CD media, the track pitch 208 is approximately 1.6 μm, and for DVD media the track pitch 208 is approximately 0.74 μm. For purposes of clarity by example, only a portion of the spiral track 208 is shown. The spiral track 208 includes a multiplicity of symbols 218₁ through 218_{N} (collectively referred to as symbols 218), where N is an integer that is equal to or greater than 1. For example, for DVD media, there may be on the order of 15 million symbols 218 within the spiral track 208. For simplicity, only symbols 218₁, 218₁₀₀, 218₅₀₀, 218₁₀₀₀, and 218₅₀₀₀ are shown. Each of the symbols 218 is characterized by a symbol number and a position on the recording surface 107. The symbol 218₁ is the first symbol within the spiral track 208. In one embodiment, the position of each of the symbols 218 is identified a radial location with respect to a predefined radial reference, and an angular location with respect to a predefined angle reference. The predefined radial reference may be a center 207 of the master 106. The predefined angle reference may be the first symbol 218₁ stored on the track 208, although other angle references may be used and are described below. The symbols 218 are consecutively numbered 1 through N from the inner diameter 206 to the outer diameter 204.

For example, an angular location 212 of the recording surface 107 with respect to the start of the first symbol 218₁ is assigned a value of 0°. Angular locations with respect to the starts of other symbols 218 are assigned values within the range between 0° and 359° in counterclockwise fashion. Thus, the symbol 218₁₀₀ may be characterized by a vector 216 having a radius, r₁, and an angle of 180°. Those skilled in the art will appreciate that other coordinate schemes for position of the symbols 218 may be used. For example, the coordinate system may be based on the position of another symbol other than the first symbol 218₁ within the spiral track 208, or may be based on the relative position of any number of symbols. In addition, the angular location used to characterize the symbols may be with respect to other portions of the symbols 218, such as the ends or midpoints thereof.

As described above, the physical position of the symbols 218 within the spiral track 208 is unique to the given master 106. For example, while the symbol 218₁₀₀ has an angular position of 180° and a radial position of r, on one master produced by the recording system 100, the symbol 218₁₀₀ will have a different angular position and radial position on another master produced by the recording system 100. Stated differently, while the symbol 218₁₀₀ and the symbol 218₁₀₀₀ have the same angular location on one master, the symbols 218₁₀₀ and 218₁₀₀₀ will have different angular locations on another master. As described in detail below, the invention utilizes the position and number of at least one of the symbols 218 to identify unique physical indicia for the master 106.

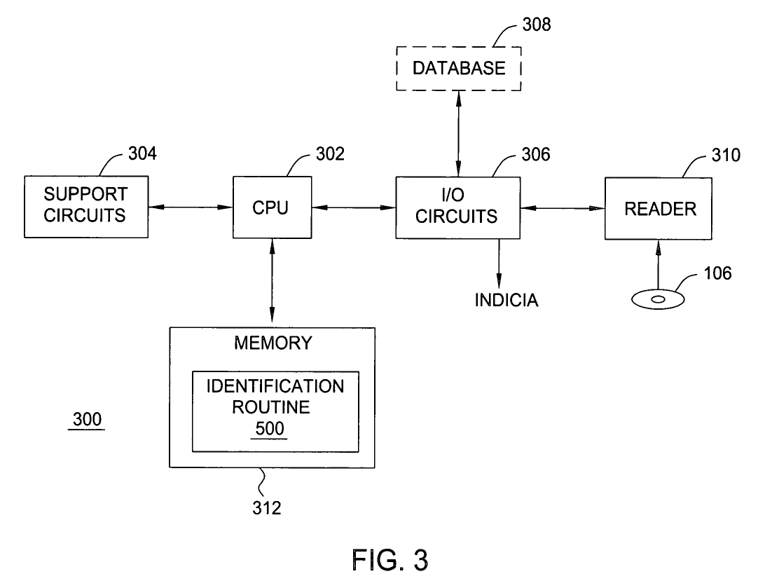

FIG. 3 depicts a block diagram showing one embodiment of a system 300 for identifying unique physical indicia for a digital storage medium in accordance with the invention. The system 300 comprises a central processing unit (CPU) 302, a memory device 312, a variety of support circuits 304, an input/output (I/O) circuit 306, and a reader 310. The CPU 302 can be any type of processor or microcontroller known in the art. The support circuitry 304 for the CPU 302 includes conventional cache, power supplies, clock circuits, data registers, I/O interfaces and the like. The I/O circuit 306 may be coupled to a conventional keyboard, mouse, printer and interface circuitry adapted to receive and transmit data, such as data files and the like. The I/O circuit 306 may also be coupled to a database 308. The memory device 312 comprises read/write random access memory (RAM), read only memory (ROM), hard disk storage, floppy disk storage, compact disk storage, or any combination of these and similar storage devices. The reader 310 reads symbol-data from a digital storage medium in a known manner. For example, the reader 310 is capable of determining the number and position of each symbol stored on the master 106 or a replica thereof.

The memory device 312 stores the program or programs (e.g., identification routine 500) that are executed to implement the processes of the invention. Although the invention has been disclosed as being implemented as an executable software program, those skilled in the art will understand that the invention may be implemented in hardware, software, or a combination of hardware and software. Such implementations may include a number of processors independently executing various programs and dedicated hardware such as application specific integrated circuits (ASICs).

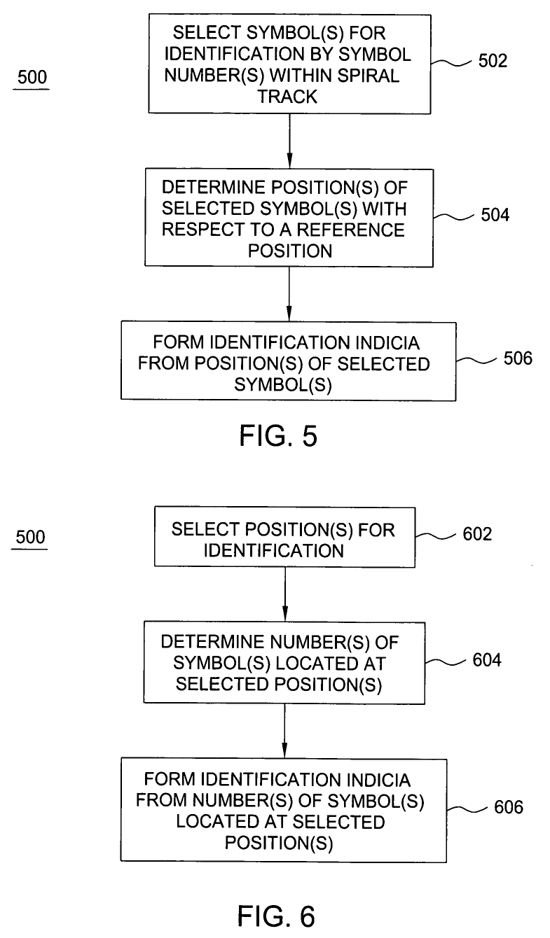

FIG. 5 depicts a flow diagram showing one embodiment of a process 500 for identifying unique physical indicia for a digital storage medium in accordance with the invention. The process 500 may be performed by the system 300 of FIG. 3. The process 500 begins at step 502, where one or more symbols are selected for identification by symbol number within the spiral track of the digital storage medium. At step 504, positions of the one or more selected symbols are determined with respect to a reference position. At step 506, identification indicia is formed using the determined positions of the one or more selected symbols.

For example, referring to FIG. 2, the symbol 218₅₀₀₀ may be selected for identification. In one embodiment, the radial position reference is the center 207, and the angular position reference is the start of the first symbol 218₁. The position of the symbol 218₅₀₀₀ may be represented by a vector 214 having a radial location, r₃, and an angular location of θ°. The two-dimensional position (radial location and angular location) of the symbol 218₅₀₀₀ is used to form identification indicia for the master 106. The process may be repeated for any number of additional symbols 218 within the spiral track 208.

FIG. 6 depicts a flow diagram showing another embodiment of a process 500 for identifying unique physical indicia for a digital storage medium in accordance with the invention. In this embodiment, process 500 begins at step 602, where one or more positions with respect to a reference position on the digital storage medium are selected for identification. The selected positions may be a specific angular location or a combination of a specific angular location and radial location. At step 604, the numbers of the symbols located at the one or more selected positions are determined. At step 606, identification indicia is formed using the numbers of the symbols located at the one or more selected positions.

For example, referring to FIG. 2, the radial position reference is the center 207, and the angular position reference is the start of the first symbol 218₁. The angular location corresponding to 180° may be selected for identification. The symbol numbers are determined for the symbols disposed along the selected angular location, for example, the symbols 218₁₀₀ and 218₁₀₀₀. That is, the 100^{th} and 1000^{th} symbols are determined to be located at an angular location of 180°. Alternatively, both the angular location of 180° and the radius r₂ may be selected for identification. The symbol number is determined for the symbol disposed at the selected position, for example, the symbol 218₁₀₀₀. That is, the 1000^{th} symbol is determined to have a location indicated by a vector 220 having an angular location of 180° and a radius of r₂. In either embodiment, the symbol numbers may be used to form identification indicia for the master 106. Again, this process may be repeated for any number of additional positions on the recording surface 107.

The embodiments of process 500 described in FIGS. 5 and 6 may be incorporated into the recording system 100 shown in FIG. 1. In such an embodiment, the system 300 of FIG. 3 is incorporated into the recording system 100. In this manner, each master 106 produced by the recording system 100 may be fingerprinted during, or subsequent to, fabrication.

Those skilled in the art will appreciate that other types of relations between symbols may be used to form identification indicia in accordance with the invention. In general, at least one physical attribute on the recording surface 107 of the master 106 is uniquely determined. As described above, the at least one physical attribute may be an association between at least one position on the recording surface 107 of the master 106 and at least one symbol stored on the master 106. The association between positions and symbol numbers may be in the form of determined positions for symbols having a specific symbol numbers. Alternatively, the association between positions and symbol numbers may be in the form of determined symbol numbers for specific positions. In yet another embodiment, the relative positions between various pairs of symbols having specific symbol numbers may be recorded, thereby obviating the need to select a position reference. Those skilled in the art may readily devise other associations between positions and symbol numbers that are within the spirit and scope of the invention, including combinations of the various association schemes described herein.

In addition, those skilled in the art will appreciate that various types of identification indicia may be formed from the associations between positions and symbol numbers. The identification indicia may be the actual association between positions and symbol numbers (i.e., symbol 100 has an angular location of 180° and a radial location of r₁), or some other recordable form corresponding to the association between positions and symbol numbers. For example, the identification indicia may be an alphanumeric string output from an algorithm that processes the determined positions of various symbol numbers. In another example, the identification indicia may be an alphanumeric string output from an algorithm that processes the determined symbol numbers of various positions. Furthermore, as described above, the identification indicia may be stored within a database and/or recorded in some other manner, such as in label form on the master recording source and the replicas thereof.

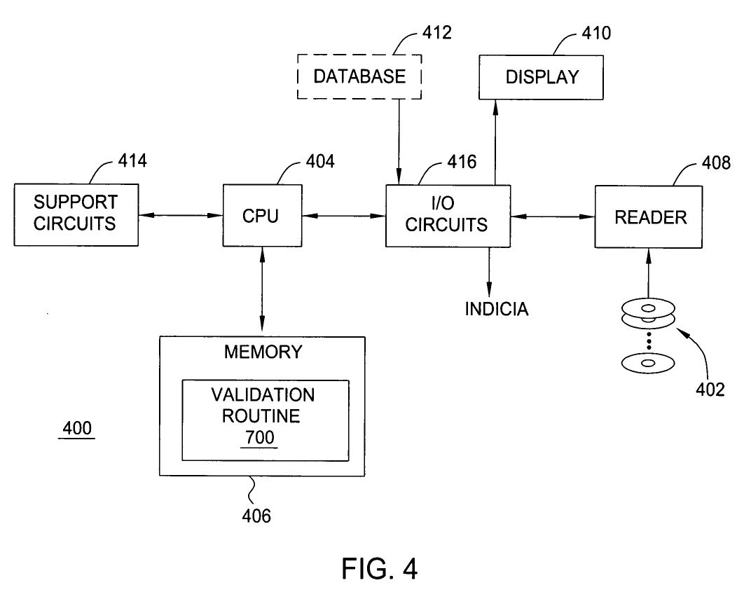

The unique physical indicia identifying a particular digital storage medium in accordance with the invention may be used to associate a master digital recording source with a replica optical storage medium. FIG. 4 depicts a block diagram showing an embodiment of a system 400 for associating a master digital recording source with a replica optical storage medium in accordance with the invention. The system 400 comprises a CPU 404, a memory device 406, a variety of support circuits 414, an I/O circuit 416, a display 410, and a reader 408. The CPU 404 can be any type of processor or microcontroller known in the art. The support circuitry 414 for the CPU 404 includes conventional cache, power supplies, clock circuits, data registers, I/O interfaces and the like. The I/O circuit 416 may be coupled to a conventional keyboard, mouse, printer and interface circuitry adapted to receive and transmit data, such as data files and the like. The I/O circuit 416 may also be coupled to a database 412. The memory device 406 comprises read/write random access memory (RAM), read only memory (ROM), hard disk storage, floppy disk storage, compact disk storage, or any combination of these and similar storage devices. The reader 408 reads symbol-data from a digital storage medium in a known manner. For example, the reader 408 is capable of determining the number and position of each symbol stored on the master on a replica optical storage medium 402.

The memory device 406 stores the program or programs (e.g., validation routine 700) that are executed to implement the processes of the invention. Although the invention has been disclosed as being implemented as an executable software program, those skilled in the art will understand that the invention may be implemented in hardware, software, or a combination of hardware and software. Such implementations may include a number of processors independently executing various programs and dedicated hardware such as ASICs.

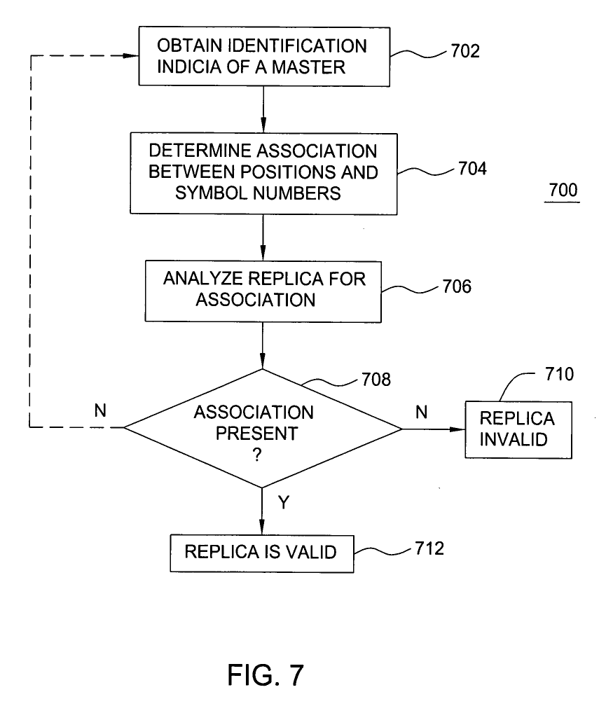

FIG. 7 depicts a flow diagram showing one embodiment of a process 700 for associating a digital recording source with a digital storage medium in accordance with the invention. Process 700 may be performed by system 400 of FIG. 4 to validate replica optical storage media. Process 700 begins at step 702, where identification indicia corresponding to a master digital recording source is obtained. The identification indicia may be obtained from a database or from a replica optical storage medium. At step 704, an association between positions and symbol numbers is determined from the identification indicia. As described above, this association is unique to a particular master digital recording source. At step 706, a replica optical storage medium is analyzed to determine if the association between positions and symbol numbers is present. At step 708, if the association is present, the process 700 proceeds to step 712, where the replica is validated. If the association is not present, the process 700 proceeds to step 710 where the replica is invalidated. Alternatively, the process 700 may proceed to step 702 and obtain new identification indicia for another master digital recording source.

Those skilled in the art will appreciate that other types of matching and/or sorting processes for associating a digital recording source with a digital storage medium may be used. In general, a given digital storage medium may be matched with the digital recording source that was used to make the digital storage medium using the identification indicia associated with the digital recording source.

A method and apparatus for identifying a digital recording source has been described. The invention may advantageously be used to detect unauthorized copies of a digital recording source. For example, a master DVD recording source may be fingerprinted during fabrication in accordance with the invention. Replica DVD media may then be reproduced using the fingerprinted DVD recording source and sold. When a particular shipment of replica DVD media arrives at customs, for example, an agent may randomly select a DVD medium, test the DVD medium, and determine whether the DVD medium was manufactured by an authorized master recording source, or whether the DVD medium is an unauthorized copy.

While the foregoing is directed to an illustrative embodiment of the present invention, other and further embodiments of the invention may be devised without departing from the basic scope thereof, and the scope thereof is determined by the claims that follow.

1. A method of uniquely identifying a digital storage medium, comprising:
determining at least one physical attribute of a recording surface; and
forming identification indicia in response to the at least one physical attribute.

2. The method of claim 1, wherein the step of determining at least one physical attribute comprises:
associating at least one position on the recording surface with at least one data unit stored on the digital storage medium.

3. The method of claim 2, wherein the step of associating comprises:
selecting a plurality of data units by number; and
determining a position on the recording surface of each of the plurality of data units.

4. The method of claim 3, wherein the position of each of the plurality of data units includes an angular location relative to an angular location of another data unit stored on the digital storage medium, and a radial location relative to a center of the digital storage medium.

5. The method of claim 4, wherein the identification indicia corresponds to the position of each of the plurality of data units.

6. The method of claim 2, wherein the step of associating comprises:
selecting at least one position by an angular location; and
determining a number for each of a plurality of data units located along the at least one position.

7. The method of claim 2, wherein the step of associated comprises:
selecting at least one position by an angular location and a radial location;
determining a number for a data unit located at the at least one position.

8. The method of claim 2, wherein the at least one data unit includes a symbol associated with modulated data.

9. The method of claim 2, wherein the digital storage medium is a digital versatile disc.

10. The method of claim 2, wherein the digital storage medium is a master digital recording source.

11. The method of claim 1, further comprising at least one of:
storing the identification indicia in a database; and
labeling the digital storage medium with the identification indicia.

12. A method of associating a digital recording source with a digital storage medium, comprising:
obtaining identification indicia associated with the digital recording source;
determining at least one physical attribute of a recording surface in response to the identification indicia; and
comparing the identification indicia with the at least one physical attribute.

13. The method of claim 12, wherein the step of determining at least one physical attribute comprises:
associating at least one position on the recording surface with at least one data unit stored on the digital storage medium.

14. The method of claim 13, wherein the step of associating comprises:
selecting a plurality of data units by number; and
determining a position on the recording surface of each of the plurality of data units.

15. The method of claim 14, wherein the identification indicia corresponds to the position of each of the plurality of data units.

16. The method of claim 13, wherein the step of associating comprises:
selecting at least one position by an angular location; and
determining a number for each of a plurality of data units located along the at least one position.

17. The method of claim 13, wherein the step of associated comprises:
selecting at least one position by an angular location and a radial location;
determining a number for a data unit located at the at least one position.

18. The method of claim 13, wherein the at least one data unit includes a symbol associated with modulated data.

19. The method of claim 12, wherein the step of obtaining comprises at least one of:
retrieving the identification indicia from a database; and
retrieving the identification indicia from a label on the digital recording medium.

20. The method of claim 12, wherein the digital storage medium is a digital versatile disc.

21. The method of claim 20, wherein the digital recording source is a master and the digital versatile disc is a replica of the master.

22. An apparatus for of uniquely identifying a digital storage medium, comprising:
a reader for determining at least one physical attribute of a recording surface; and
a means for forming identification indicia from the at least one physical attribute.

23. The apparatus of claim 22, wherein the at least one physical attribute is an associate between at least one position on the recording surface and at least one symbol stored on the digital storage medium.

24. The apparatus of claim 22, further comprising:
a database for storing the identification indicia for a plurality of the digital storage medium.

25. The apparatus of claim 22, wherein the digital storage medium is a digital versatile disc.

26. The apparatus of claim 25, wherein the digital versatile disc is a master.

27. An apparatus for associating a digital recording source with a digital storage medium, comprising:
a reader for analyzing the digital storage medium to determine at least one physical attribute of a recording surface; and
a means for obtaining identification indicia associated with the digital recording source and comparing the identification indicia with the at least one physical attribute.

28. The apparatus of claim 27, wherein the at least one physical attribute comprises an association between at least one position on the recording surface and at least one data unit stored on the digital storage medium.

29. The apparatus of claim 27, further comprising:
a database for storing the identification indicia for a plurality of the digital storage medium.

30. The apparatus of claim 27, wherein the digital storage medium is a digital versatile disc.

31. The apparatus of claim 30, wherein the digital recording source is a master and the digital versatile disc is a replica of the master.

32. An apparatus for identifying a master used to manufacture a digital storage medium, comprising:
a digital storage medium reader for reading identification indicia from the digital storage medium;
a means for comparing the identification indicia to a database of identification indicia of maters; and
a display for displaying a result of the comparison.

33. The apparatus of claim 32, wherein the identification indicia comprises at least one physical attribute of a recording surface.

34. The apparatus of claim 32, wherein the at least one physical attribute comprises an association between at least one position on the recording surface and at least one data unit stored on the digital storage medium.

35. A method of identifying a master used to manufacture a digital storage medium, comprising:
reading identification indicia from the digital storage medium;
comparing the identification indicia to a database of identification indicia of masters; and
displaying a result of the comparison.

36. The method of claim 35, wherein the step of reading identification indicia comprises:
determining at least one physical attribute of a recording surface.

37. The method of claim 36, wherein the step of determining at least one physical attribute comprises:
associating at least one position on the recording surface with at least one data unit stored on the digital storage medium.
